(19) United States
(12) Patent Application Publication
(10) Pub. No.: US 2013/0175057 A1
(43) Pub. Date: Jul. 11, 2013

(54) METHOD FOR PROVIDING A FIRE-RESISTANT COMPONENT

(71) Applicant: Steve Klancnik, Lake Barrington, IL (US)

(72) Inventor: Steve Klancnik, Lake Barrington, IL (US)

(21) Appl. No.: 13/346,384

(22) Filed: Jan. 9, 2012

(51) Int. Cl. A62C 3/00

(52) U.S. Cl. 169/45; 169/48

(57) ABSTRACT

A method for providing a fire-resistant component is disclosed that includes the steps of obtaining a component, obtaining a fire-resistant sock comprising an enclosure with an open end, placing the component within the fire-resistant sock through the open end, and sealing the open end of the fire-resistant sock to form a seal by affixing a portion of the open end to the component.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

Methods for providing components, such as mattresses and the like, that are resistant to fire are disclosed herein.

2. Description of the Background of the Invention

For decades mattress manufacturers have been concerned with mattress fires. Tens of thousands of bedroom fires have been attributed to cigarette ignition of mattresses resulting from people smoking in bed. Tens of thousands of additional fires may be attributed to open flame ignition of mattresses. Given the large number of fires, Federal standards were introduced in an attempt to limit the spread of fires that originated on a mattress.

Studies conducted to improve the understanding of mattress fires led to the development of a test apparatus that could accurately and consistently simulate a burning bedclothes ignition source. The tests involved placing a mattress/foundation on top of a steel twin-sized bed frame which, in turn, rested on a cement fiberboard surface that formed the bottom of a catch pan. A pair of gas burners was designed to mimic the thermal impact of burning bedclothes. One burner was placed to direct a flame onto a surface top of a mattress surface while the second was placed to direct a flame onto a mattress side. The flame generated by the side burner was allowed to burn for 50 seconds while the flame from the top burner burned for 70 seconds. The fires generated by these burners were monitored and it was observed that a typical mattress reached the flashover point in approximately three minutes. Flashover is the point at which the entire contents of a room are ignited simultaneously by radiant heat, making conditions in the room untenable and safe exit from the room impossible. At flashover, room temperatures typically exceed 600-800° C. (approximately 1100-1470° F.). About two-thirds of all mattress fatalities are attributed to mattress fires that lead to flashover. This accounts for nearly all of the fatalities that occur outside the room where the fire originated and about half of the fatalities that occur within the room of origin.

As a result of these studies, at least one State enacted a regulation (Technical Bulletin 603) that required that a fire on a mattress could not exceed 25 mega joules of heat in the first 15 minutes of the fire, or a peak rate of heat release of 200 kW over a 30-minute period. A Federal regulation by the Consumer Product Safety Commission superseded the State regulation (see 16 CFR Part 1633—Standard for Flammability (Open Flame) of Mattress Sets; Final Rule, dated Mar. 15, 2006). The Federal regulation requires mattresses to not exceed either of a) a total heat release of 15 mega joules in the first 10 minutes of the test or b) a maximum heat release rate of 200 kW during the first 30 min. Further, regardless of State and Federal mattress burn standards, manufacturers of mattresses continue to develop technology to better minimize heat release during mattress fires to provide for greater consumer safety.

By reducing the size and growth rate of a fire, it is possible to reduce bed fire casualties by one-half to two-thirds. This is because extra time to escape the residence is provided. Furthermore, additional time is also provided for a person on the mattress to escape with only isolated burns, if any.

In practice, mattress manufacturers follow either or both of two approaches to fire risk reduction: (a) reduce the likelihood of sustained ignition and (b) mitigate the consequences of an ignition. To help achieve these goals, typical fire-resistant mattresses have a fire-resistant barrier located near the outer layer of the mattress, with the outer layer being made of a quilt or ticking material. A more effective approach is to manufacture mattresses that incorporate fire-resistant compartments formed by encapsulating flammable materials within layers of fire-resistant material, such as is disclosed in U.S. patent Ser. No. 10/934,971. However, newer approaches to fire risk reduction are needed that minimize the costs of mattress manufacture while maintaining or improving fire resistance and the aesthetics in mattresses.

### SUMMARY OF THE INVENTION

According to one aspect of the present disclosure, a method for providing a fire-resistant component includes obtaining a component, obtaining a fire-resistant sock comprising an enclosure with an open end, placing the component within the fire-resistant sock through the open end, and sealing the open end of the fire-resistant sock to form a seal by affixing a portion of the open end to the component.

According to another aspect of the present disclosure, a method for providing a fire-resistant component includes placing a component within a fire-resistant sock through an open end thereof and forming a seal in the open end of the fire-resistant sock by adhering a portion of the open end to the component with an adhesive. The formation of the seal creates a continuous char barrier that extends around the component to retard combustion of the component on all sides when contacted with an open flame.

According to a further aspect of the present disclosure, a method for providing a fire-resistant component includes the steps of obtaining a component including multiple layers, obtaining a fire-resistant sock including an enclosure with an open end, placing the component within the fire-resistant sock through the open end, forming first, second, third and fourth flaps at the open end of the fire-resistant sock, applying an adhesive to at least one of an end of the component and one of the first, second, third, and fourth flaps, and adhering at least one of the first, second, third, and fourth flaps to another flap or to the end of the component.

### BRIEF DESCRIPTION OF THE DRAWINGS

FIG. 1 depicts an isometric view of a component, such as a mattress, and a fire-resistant sock prior to placement of the component within the sock;

FIG. 2 illustrates an isometric view of the component within the fire-resistant sock;

FIG. 3 depicts an isometric view of the component within the fire-resistant sock and flaps formed in the end of the fire-resistant sock;

FIG. 4 depicts an isometric view of the component within the fire-resistant sock wherein the side flaps of the fire-resistant sock are sealed and an adhesive has been applied to the back surfaces thereof in order to seal the top flap of the fire-resistant sock;

FIG. 5 depicts an isometric view of the component within the fire-resistant sock with an adhesive applied to an exposed surface of the top flap for affixation of the bottom flap thereto; and

FIG. 6 illustrates an isometric view of the component sealed within the fire-resistant sock.

### DETAILED DESCRIPTION

The present disclosure relates to components, including mattresses, cushions, pillows, mattress supports, such as box springs, pads, mats, and the like. The present disclosure further relates to methods to render such components fire-resistant while maintaining their aesthetic appeal. By adding fire-resistance to all sides of a component in an efficient manner that maintains aesthetic appeal, improved fire safety may be provided to consumers.

Contemplated components may be part of a conventional item of furniture, such as a bed equipped with a bed frame. In this scenario, the component may be a mattress that is placed upon the bed frame, perhaps atop of a box spring or other mattress support. As an alternative, the component may form an integral part of an item of furniture. For example, the component may be in the form of a padded sleeping surface of a foldable cot, wherein the sleeping surface incorporates one or more structural components of a support frame of the cot. In this way, the sleeping surface is affixed to the support frame of the cot. In other examples, the component may be a cushion of a chair or a couch, a throw pillow, a pet pillow, a portion of a car seat, or any other padded surface.

Components that may be rendered fire-resistant may be of any desired size according to the intended use. In the context of mattresses, a mattress may have a length of about 73 to about 82 inches and a width of about 37 to about 75 inches. However, a mattress may be shorter or longer. Indeed, many mattresses may be manufactured to conform to standard size conventions, such as, a crib mattress size, a twin bed size, a twin XL size, a full bed size, a full XL size, a queen bed size, a king bed size, and a California king size.

In one embodiment depicted in FIG. 1, a contemplated component comprises a bedding component 10 that includes a top portion 12, a middle portion 14, and a bottom portion 16. The top portion 12 may be comprised of x+m layers, wherein x=0, and m=0-infinity, and wherein each of x+m layers is affixed to any adjacent layer on a top surface and/or a bottom surface thereof. An optional intermediate portion 13 may also be comprised of x+m layers, wherein x=0, and m=0-infinity, and wherein each of x+m layers is affixed to any adjacent layer on a top surface and/or a bottom surface thereof. For example, top portion 12 and/or optional intermediate portion may each include 0 layers, or 1-6 layers, or 2-8 layers, or 3-12 layers, or 4-20 layers. The middle portion 14 and bottom portion 16 may each be separately comprised of x+n layers, wherein x=0, and n=1-infinity, and wherein each of x+n layers is affixed to any adjacent layer on a top surface and/or a bottom surface thereof. For example, middle portion 14 or bottom portion 16 may include 1-6 layers, or 2-8 layers, or 3-12 layers, or 4-20 layers. However, the sum of all the layers of the bedding component is greater than or equal to 2, i.e., 2(x+m)+2(x+n)≧2, and more preferably the sum of all layers is between 2 and 20.

Component layers may be of any thickness. For example, in several preferred embodiments, the component layer is less than or about ½ inch, less than or about 1 inch, less than or about 2 inches, less than or about 3 inches, less than or about 4 inches, less than or about 5 inches, less than or about 6 inches, less than or about 8 inches, or less than or about 12 inches, and all thicknesses in between. Component layers may also be of varying widths and lengths that are not necessarily tied to the size of the component. For example, a mattress may include a first layer with a first width and a second layer with a second width, where the first width is wider or narrower than the second width. When a layer is wider than the bedding component, it may be folded in upon itself or folded upwardly or downwardly along the side of the bedding component to form a portion of a sidewall of the bedding component. Similar variability with respect to layer length is also possible.

Layers may be sprayed-on, injection molded, extruded, coextruded, laminated, and the like. Layers may be affixed by any suitable means known in the art. For example, layers may be stapled, tacked, welded, laminated, mechanically affixed via friction or interference fit, adhered via an adhesive, a glue, a cement, or other material with adhesive properties, stitched, affixed via hook and loop fastener, a zipper, a Dennison-style tag, snaps, and/or other reversible means.

Layers may include a fabric, a natural fiber, a synthetic fiber, a ticking layer, a quilt layer, a thread layer, a film, a foam, a gel, a gel foam, a woven layer, a nonwoven layer, a fire-resistant layer, a non-skid layer, and combinations thereof. A component core layer may be any mattress core construction including a foam core, a gel foam core, latex core, an inner spring layer, or a layer of individually wrapped coils. For example, fire-resistant layers contemplated for use herein include PFG880 Precision Fabrics Group (Greensborough, N.C.) and Tietex C243 (Tietex International, Ltd., Spartanburg, S.C.). Additional fire resistant fabrics are known in the art. Further, additional materials that may be used in the construction of the components contemplated herein include those disclosed in Attorney Docket Nos. 135845.01311, entitled “Bedding Component With Fire-resistant Laminate,” and 135845.01315, entitled “Component with Multiple Layers,” each filed on the same date as the present disclosure (numbers to be assigned).

Components of the present disclosure may be rendered fire-resistant by being enclosed within a fire-resistant layer or “sock” that completely surrounds the component. Fire-resistant socks include materials, such as fabrics, spun-bonded materials, stitch-bonded materials, woven materials, nonwoven materials, films, and other flexible and/or stretchable materials that are inherently fire-resistant or that have been treated with a fire-resistant material or both. The fire-resistant sock may be formed with a seam along at least one end, such as in a tube, to form an enclosure with an opening into which a component may be inserted. Alternatively, fire-resistant socks may be seamless. One fire-resistant sock material that may be used is Springs Creative fire-resistant sock available from Springs Creative (Rock Hill, S.C.), which is made of about 61% modacrylic and about 39% silica (fiberglass), has a density of about 7.0 oz/yd², and a thickness of about 0.02 inches. Additional fire-resistant materials may include fire-resistant polyesters and/or fire-resistant rayon, and the like. While fire-resistant layers of the present disclosure may be rigid materials, fire-resistant socks are typically “transparent” to the feel of the component. Therefore, in the context of a mattress, the fire-resistant sock is not readily noticeable by an individual resting thereon.

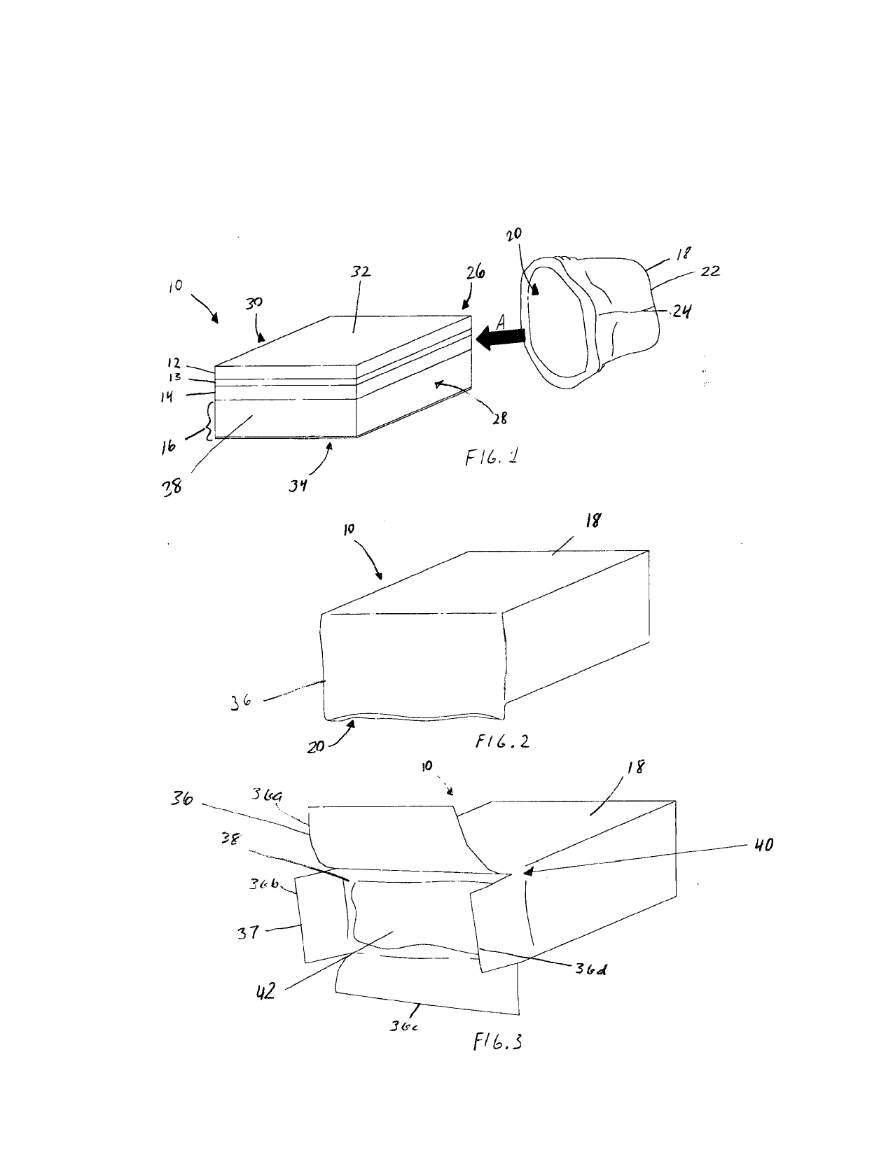

A method for rendering a component fire-resistant by enclosure within a fire-resistant sock is depicted in FIGS. 1-6. As shown in FIG. 1, a fire-resistant sock 18 is provided with an open end 20, a closed end 22, and an optional seam 24. The fire-resistant sock 18 is advanced in a direction A to align an end 26 of the component 10 with the open end 20 of the fire-resistant sock. The fire-resistant sock 18 may be unrolled, pulled, or otherwise disposed over the component 10 so as to form a snug or tight fit over the end 26, the first 28 and second 30 sides, the top surface 32, and the bottom surface 34 of the component, as shown in FIG. 2.

Fire-resistant socks may be of any size necessary to form a tight fit over a component 10. Further, the fire-resistant sock 18 may be tailored by adjusting the amount of material in the fire-resistant sock along the optional seam 24 before or after being applied to the component 10 to ensure a tight fit to the component. When a fire-resistant sock must be adjusted or repaired a fire-resistant thread, such as Tex 50 para-amid thread and similar threads, available from Saunders (Gastonia, N.C.) and/or 12/1 para-amid yarn and similar yarns available from Pharr Yarns (McAdenville, N.C.) may be used to form a seam 24 and therefore maintain the fire-resistant integrity of the fire-resistant sock. Additional fire-resistant threads may be used.

As shown in FIGS. 2 and 3, an end portion 36 of the fire-resistant sock 18 drapes over an end 38 of the component 10 when the fire-resistant sock is fully advanced over the component to form a tight fit over the end 26, the first 28 and second 30 sides, the top surface 32, and the bottom surface 34 of the component. According to one embodiment shown in FIG. 3, the end portion 36 of the fire-resistant sock 18 is sealed over the end 38 of the component 10 by first cutting the end portion 36 to form end flaps 36a, 36b, 36c, and 36d. The end flaps 36a-d have a length dimension that extends from a peripheral edge 37 of the end portion 36 to a point 40 adjacent the end 38 of the component 10. It has been found that positioning the point 40 approximately 2-3 inches from the end 38 ensures that adequate fire-resistance of the component is achieved when the fire-resistant sock 18 is sealed. In other embodiments, fewer or more end flaps may be made as desired.

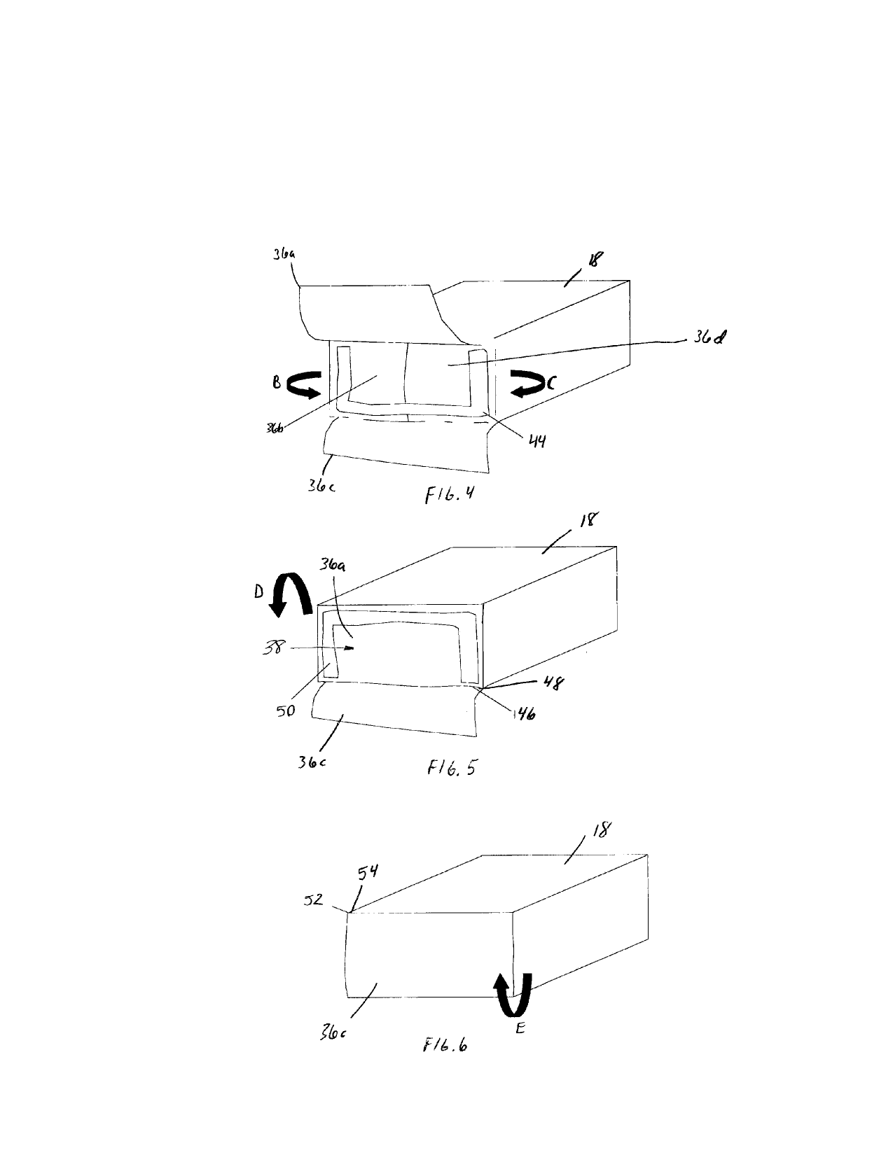

To form a fire-resistant seal in the end 36 of the sock 18, an adhesive 42 is first applied to the end 38 of the component 10 (see FIG. 3). In the present embodiment, the adhesive 42 is applied substantially uniformly over the end 38. Side flaps 36b and 36d are folded inwardly as indicated by arrows B and C, respectively, in FIG. 4 to affix the side flaps to the component 10. Adhesives that may be used in the present disclosure include any adherent materials or fasteners known in the art. Specific examples of adhesives include hot melt, water-based, and pressure-sensitive adhesives, fire-resistant adhesives, and mixtures thereof. Hot melt adhesives that may be used include those available from Henkel (Rocky Hill, Conn.) and UPACO adhesives available from Worthen Industries (Nashua, N.H.). Water-based adhesives that may be used include water-based adhesives under the SIMALFA brand available from Alfa Adhesives, Inc. (Hawthorne, N.J.). Adhesives may be applied by spraying, brushing, rolling, or any other suitable manner according to the type of adhesive to be applied. For example, when applied by spraying, adhesives may be applied in a pattern that results in a band of adhesive about 2 or more inches in width. The adhesives are applied such that the flaps are secured within about 2 inches or less of an edge and/or corner.

Once side flaps 36b and 36d are affixed to the end 38 of the component 10, an adhesive 44, which may be the same or different than adhesive 42, is applied to the side flaps 36b, 36d, as shown in FIG. 4. The adhesive 44 is preferably applied in a “U” shaped pattern, such as shown in FIG. 4, which aids in the formation of the fire-resistant seal by creating an unbroken barrier that prevents the leakage of gas or molten material through the end 36 of the sock 18 when the component is exposed to fire. Top flap 36a is then folded downwardly, as shown by arrow D in FIG. 5, to affix the top flap to the component 10 by means of the adhesive 44. An edge 46 of the top flap 36a (which corresponds to the peripheral edge 37) is aligned with a bottom edge 48 of the component 10 (for example, an edge defining bottom surface 34) in order to fully cover the end 38 thereof.

In a process similar to the affixation of top flap 36a, bottom flap 36c is affixed to the top flap by applying an adhesive 50 in an inverted “U” pattern, as shown in FIG. 5. Once the adhesive 50 is applied, bottom flap 36c is folded upwardly, as indicated by arrow E of FIG. 6, to seal the fire-resistant sock 18 around the component 10. An edge 52 of the bottom flap 36c (which corresponds to the peripheral edge 37) is aligned with a top edge 54 of the component 10 (for example, an edge defining top surface 32) in order to fully cover the top flap 36a. The resultant seal has the same fire-resistance as the remainder of the fire-resistant sock 18 to provide a uniform fire-resistant barrier to components contained therein.

In another embodiment, the adhesive used to affix the end flaps 36a-d need not be fire-resistant because the sealed fire-resistant sock maintains fire-resistance subsequent to adhesive failure from exposure to fire for a number of reasons. First, the fire-resistant sock material, while “transparent” to a consumer, in that, it is not readily noticeable when resting thereon, becomes more rigid when exposed to flame. Therefore, while the adhesive may fail by exposure to fire, the increased rigidity of the fire-resistant sock effectively forms an interference fit where the outermost flaps 36a and 36c prevent the innermost flaps 36b and 36d from opening due to their rigidity. Second, it has been found that by having the outermost flap 36c folded in an upward direction as indicated by arrow E to seal the fire-resistant sock, when the adhesive fails upon exposure to fire, the outermost flap falls into the flames to smother flames therebelow.

Further advantages of the present disclosure include the provision of a fire-resistant seal to a fire-resistant sock that avoids leaving excess material or a loose fit. More importantly, the method of sealing the fire-resistant sock and the materials used in the sock guard against burn test failure as explained above and illustrated in the Examples below. In effect, a properly sealed fire-resistant sock 18 provides a continuous char barrier that extends around the component 10 and retards combustion of the component from all sides. The char barrier inhibits the flow out of the sock of gases and molten materials, such as polyurethane, that result from heat exposure of the component during a fire. As a result, the fire-resistant sock 18 slows or stops flammable materials of the component from contributing to a fire to improve fire safety of components, such as mattresses.

### EXAMPLES

To determine the fire-resistant properties of the components sealed within fire-resistant socks according to the present method, a flammability test was performed on a representative mattress prototype. The prototype included from top down: 1) an outer upholstery layer of cotton/polyester; 2) a polyurethane foam bilayer; 3) a latex foam layer; 4) a synthetic latex/polyurethane foam layer; 5) a heat dissipating foam layer; 6) a 6″ thick polyurethane foam core; and 7) a PFG-880 fire-resistant laminate. The prototype was sealed within a Springs Creative fire-resistant sock. The prototype was tested on a standard wood pine frame foundation, with polyester/polypropylene ticking, pillow fill, a bottom non-skid polyester layer, a non-fire-resistant pad, and polypropylene dust over. The test was carried out in compliance with 16 CFR Part 1633—Standard for Flammability (Open Flame) of Mattress Sets. The test was performed once for three identical mattress sets (samples A, B and C). Results for the test are below in Table No. 1.

TABLE NO. 1
Results for Flame Test of Sealed Fire-resistant Sock

| | | Peak Heat | | |
|---|---|---|---|---|
| | | Release Rate, | Time to Peak | Total Heat |
| | | During first 30 | Heat Release | Release at 10 min |
| Test No. | Sample ID | minutes (kW) | Rate (min) | (MJ) |
| 1 | A | 38 | 0.5 | 5.1 |
| 2 | B | 40 | 0.5 | 4.5 |
| 3 | C | 46 | 0.5 | 5.4 |
| Average | — | 41.33 | 0.5 | 5 |

### INDUSTRIAL APPLICATION

Methods of providing components with improved fire-resistance are disclosed herein. The disclosure has been presented in an illustrative manner in order to enable a person of ordinary skill in the art to make and use the disclosure, and the terminology used is intended to be in the nature of description rather than of limitation. It is understood that the disclosure may be practiced in ways other than as specifically disclosed, and that all modifications, equivalents, and variations of the present disclosure, which are possible in light of the above teachings and ascertainable to a person of ordinary skill in the art, are specifically included within the scope of the claims. All patents and patent applications disclosed herein are incorporated by reference herein, in their entireties.

What is claimed is:

1. A method for providing a fire-resistant component, the method comprising the steps of:
a) obtaining a component;
b) obtaining a fire-resistant sock comprising an enclosure with an open end;
c) placing the component within the fire-resistant sock through the open end; and
d) sealing the open end of the fire-resistant sock to form a seal by affixing a portion of the open end to the component.

2. The method of claim 1, wherein the fire-resistance of the seal is substantially the same as the fire-resistance of the fire-resistant sock.

3. The method of claim 1, wherein the component comprises a mattress, a cushion, a pillow, a pad, or a mat.

4. The method of claim 1, wherein the fire-resistant sock comprises a fire-resistant fabric.

5. The method of claim 4, wherein the fire-resistant fabric comprises silica.

6. The method of claim 1 further comprising the step of forming a flap in the open end of the fire-resistant sock.

7. The method of claim 6, wherein the seal is formed by affixing the flap to an end of the component.

8. The method of claim 7, wherein the flap is affixed with an adhesive or a fire-resistant thread.

9. The method of claim 8, wherein the adhesive is selected from the group consisting of a hot melt adhesive, a water-based adhesive, a pressure-sensitive adhesive, a fire-resistant adhesive, and mixtures thereof.

10. A method for providing a fire-resistant component, the method comprising the steps of:
a) placing a component within a fire-resistant sock through an open end thereof; and
b) forming a seal in the open end of the fire-resistant sock by adhering a portion of the open end to the component with an adhesive,
wherein the formation of the seal creates a char barrier that extends around the component to retard combustion of the component on all sides when contacted with an open flame.

11. A fire-resistant component made according to the method of claim 10.

12. The fire-resistant component of claim 11, wherein the component comprises a mattress having a size selected from the group consisting of a crib mattress size, a twin bed size, a twin XL size, a full bed size, a full XL size, a queen bed size, a king bed size, and a California king size.

13. The fire-resistant component of claim 12, wherein the mattress comprises a top portion and a middle portion, and wherein at least one of the top portion and the middle portion comprises a foam layer.

14. The fire-resistant component of claim 13, wherein each of the top portion and the middle portion comprises a foam layer.

15. The fire-resistant component of claim 14, wherein the foam layer of the top portion is adhered to a top surface of the foam layer of the middle portion.

16. The fire-resistant component of claim 15, wherein the foam layer of the top portion and the foam layer of the middle portion each comprises a different foam material.

17. A method for providing a fire-resistant component, the method comprising the steps of:
a) obtaining a component comprising multiple layers;
b) obtaining a fire-resistant sock comprising an enclosure with an open end;
c) placing the component within the fire-resistant sock through the open end;
d) forming first, second, third and fourth flaps at the open end of the fire-resistant sock;
e) applying an adhesive to at least one of an end of the component, the first flap, the second flap, the third flap, and the fourth flap; and
f) adhering at least one of the first, second, third, and fourth flaps to another flap or to the end of the component.

18. The method of claim 17 further comprising:
adhering the first and second flaps to the end of the component;
affixing the third flap to the first and second flaps; and
affixing the fourth flap to the third flap.

19. The method of claim 18, wherein the third flap is a top flap that is affixed to the first and second flaps by folding the top flap in a downward direction, and wherein the fourth flap is a bottom flap that is affixed to the top flap by folding the bottom flap in an upward direction.

20. The method of claim 17, wherein the adhesive is applied by at least one of spraying, brushing, or rolling.
